(19) United States
(12) Patent Application Publication
(10) Pub. No.: US 2002/0065877 A1
(43) Pub. Date: May 30, 2002

(54) Methods and systems for creating and sharing customized web sites and portals

(76) Inventors: John Kowtko, Redwood City, CA (US); Norman F. Gennaro, San Carlos, CA (US); Paul Moran, Orinda, CA (US)

Correspondence Address: ALAN W. YOUNG, YOUNG LAW FIRM, P.C., Suite 106, 4370 Alpine Road, Portola Valley, CA, 94028, US

(21) Appl. No.: 09/728,782

(22) Filed: Nov. 30, 2000

(51) Int. Cl. G06F 15/16

(52) U.S. Cl. 709/203; 709/217

(57) ABSTRACT

Disclosed herein are methods and systems for products such as selling software over a computer network. The method may include steps of posting sales materials to an online collaboration tool, the online collaboration tool enabling both a sales representative and a potential customer to view the posted sales materials simultaneously. The sales materials may include a presentation, a press release, an analyst review and/or a customer reference. The potential customer's Web site may then be accessed and graphics, text and/or configuration information may be retrieved therefrom. An appearance of a generic Web site template may then be customized with the retrieved graphic, text and/or configuration information to create a customized Web site. The customized Web site may then be posted to the online collaboration tool and the customized Web site displayed for the potential customer.

### BACKGROUND OF THE INVENTION

1. Field of the Invention

This invention relates to the creation and sharing of customized Web sites, particularly in the field of sales. More particularly, the present invention relates to the field of rapid prototyping of software demos and to the sales of goods and services (such as software, for example) over a computer network. The present invention also relates novel methods and systems for the execution of a sales cycle for such goods and services.

2. Description of the Related Art

For most businesses, the cost of selling goods and services has a direct impact upon profitability. For large corporate entities employing hundreds or thousands of sales representatives, shortening the sales cycle (from initial contact with the potential customer to closing the deal) by even a single minute may directly translate into significant aggregate savings. Such savings may then be passed on to the customer or used to employ additional representatives to reach a broader segment of the market for such goods and services.

For enterprise software, such as application and database software for example, a conventional sales cycle may begin with an initial contact between the sales representative (hereafter “sales rep”) and the potential customer. This contact may be initiated either by the sales rep or by the potential customer. During the initial contact, the sales rep may establish whether there is mutual interest in pursuing the nascent relationship and may match the needs of the potential customer with a solution offered by the enterprise software vendor. This initial contact is frequently carried out over the telephone. If it is established that the vendor offers a solution that addresses the potential customer's needs, the sales rep may prepare initial sales materials, such as a brief slide presentation, press releases and/or a demonstration of the software of interest to the potential customer. As shown in step S1 of FIG. 1, the sales rep, at the beginning of a typical sales cycle, may travel to the potential customer's site or may initiate a sales call to the potential customer. If there is mutual interest, the sales rep may prepare and show initial sales materials to the potential customer, as shown at S2. At various stages of the sales cycle, the sales rep may gather additional materials from existing corporate Web sites and may then email these additional materials to the potential customer, as outlined in step S3. This in turn, may necessitate multiple callbacks to the potential customer, as shown at S4.

As suggested at S5, the costly and time consuming steps of creating customized sales materials are conventionally deferred until later in the sales cycle; that is, until the sales rep determines that the lead is solid and that the potential customer is likely to purchase the product in question. If, as shown at S6, the sales rep determines that the likelihood of purchase is high, he or she usually requests others within the vendor's organization (i.e. a technical pre-sales representative, for example) to research and prepare the customized materials, such as a customized demo. In addition to the customized demo, the sales rep and/or the technical pre-sales representative may gather relevant references of other, similarly situated customers that use the featured product, among other possibilities. These customized materials are labor-intensive and may take several days to prepare, as the sales rep must call on a team of programmers to customize the product offered for sale to the potential customer. As shown in step S7, once these customer references, customized prototypes and other customized materials are made available, the sales rep typically must schedule another in person or online meeting with the potential customer to showcase these materials. These customized materials may take the sales rep and/or the technical pre-sales representative one to five days to prepare before they may be presented to the potential customer. Therefore, the sales rep often tries to close the deal before the potential customer asks for such customized materials.

Such a fragmented and drawn out approach to selling is antithetical to the modem trend of reducing the cost and time to close a sales cycle. What are needed, therefore, are methods and systems that enable the sales cycle to close in a shorter period of time and that enable a flexible execution thereof. What are also needed are methods and systems that enable a rapid customization, prototyping and demonstration of software over a computer network such as the Internet.

### SUMMARY OF THE INVENTION

It is an object of the present invention, therefore, to provide methods and systems that enable the sales cycle to close in a short period of time and that enable a flexible execution thereof. Other objects of the present invention are to provide are methods and systems that enable a rapid customization, prototyping and demonstration of software over a computer network such as the Internet.

In accordance with the above-described objects and those that will be mentioned and will become apparent below, an embodiment of a method of creating a customized Web site for a customer, may comprise steps of selecting one of a plurality of stored generic Web site templates, each of the plurality of generic Web site templates including a plurality of customizable attributes; retrieving a graphic, text and/or configuration information from a Web site of the customer, and customizing a look of the selected generic Web site template by selectively inputting the retrieved graphic, text and/or configuration information into the customizable attributes.

A step of running at least one Web application or demo from the Web site may also be carried out, the Web application or demo being configured to extract screen display definitions from database tables within a database and to customize the extracted screen display definitions according to the retrieved graphic, text and/or configuration information. A step of inputting the retrieved graphic, text and/or configuration information into a control panel may be carried out. The control panel may be configured to apply the retrieved graphic, text and/or configuration information to the selected generic Web site template. The graphic, text and/or configuration information of the customized Web site may include the look and feel of the customer's Web site. The look and feel of the customized Web site may include color schemes, fonts, links, animation, navigation bars and/or texture of the customer's Web Site, for example. The plurality of Web site templates may include a template for an extranet portal, and intranet portal and an applications portal, for example.

The present invention is also a method for selling software online, comprising the steps of posting sales materials to an online collaboration tool, the online collaboration tool enabling both a sales representative and a potential customer to view the posted sales materials simultaneously, the sales materials including a presentation, a press release, an analyst review and/or a customer reference (for example); accessing a Web site of the potential customer and retrieving graphic, text and/or configuration information therefrom; customizing a look of a generic Web site template with the retrieved graphic, text and/or configuration information to create a customized Web site, and posting the customized Web site to the online collaboration tool and causing the customized Web site to be displayed for the potential customer.

A step of carrying out a telephone conference with the potential customer may also be carried out and the accessing and posting steps may be carried out during the telephone conference. The generic Web site template may be an extranet portal, an intranet portal and/or an applications portal, for example. A step of running at least one Web application from the customized Web site may be carried out, the Web application being configured to extract screen display definitions from database tables within a database and to modify the extracted screen display definitions according to the retrieved graphic, text and/or configuration information. A step of inputting the retrieved graphic, text and/or configuration information into a control panel may be carried out, the control panel being configured to apply the retrieved graphic, text and/or configuration information to the accessed generic Web site template. The configuration information of the customized Web site may include elements of the look and feel of the customer's Web site. For example, the look and feel of the customized Web site may include color schemes, fonts, links, navigation bars, animation and/or texture, for example, of the customer's Web Site. The sales materials and the customized Web site may be viewed by both the potential customer and the sales rep in an order determined by either party during the telephone conference. One or more applications and/or demos may be run from the customized Web site. These application(s) and/or demo(s) may also be customized by the retrieved graphic, text and/or configuration information.

The present invention may also be viewed as a system for creating and sharing a customized Web site or demo, comprising a first Web site, the first Web site including a plurality of input fields for a corresponding plurality of customizable attributes, each of the plurality of input fields being configured to accept at least one attribute of a second Web site; a plurality of generic Web site templates; and means for applying the at least one attribute of the first Web site to at least one of the plurality of generic Web site templates to generate the customized Web site or demo, the customized Web site or demo being configured to resemble a look and feel of the second Web site.

The customized Web site may include an intranet portal, an extranet portal and/or an applications portal, for example. The customizable attributes of the first Web site may include graphics, text, configuration information, color schemes, fonts, links, animations, navigation bars, texture and/or a layout of the second Web Site, for example. A Web collaboration tool may be included, the Web collaboration being configured to enable the customized Web site or demo to be simultaneously viewed and acted upon by at least a first and a second party, such as a sales rep and a potential customer, for example. The system may also include a telephone connection between the first and the second party. Moreover, the system may further include a database, the database being configured to store the plurality of generic Web site templates. For example, the database may be configured to store a Web-enabled application configured to be launched from the customized Web site. The Web-enabled application may be adapted to change its appearance according to one or more attributes from the second Web site.

### BRIEF DESCRIPTION OF THE DRAWINGS

For a further understanding of the objects and advantages of the present invention, reference should be made to the following detailed description, taken in conjunction with the accompanying figures, in which:

FIG. 1 is a flowchart of a conventional sales methodology.

FIG. 2 is a representation of a browser display showing a Web site for conducting an online sales call, according to an embodiment of the present invention.

FIG. 3 is a representation of a browser display showing the control panel for creating customized Web sites and/or demos, according to another embodiment of the present invention.

FIG. 4 is a diagram of a system for conducting online sales calls, according to a still further embodiment of the present invention.

FIG. 5 is a block diagram of a computing device with which the present invention may be practiced.

### DESCRIPTION OF THE PREFERRED EMBODIMENTS

### Functional Overview

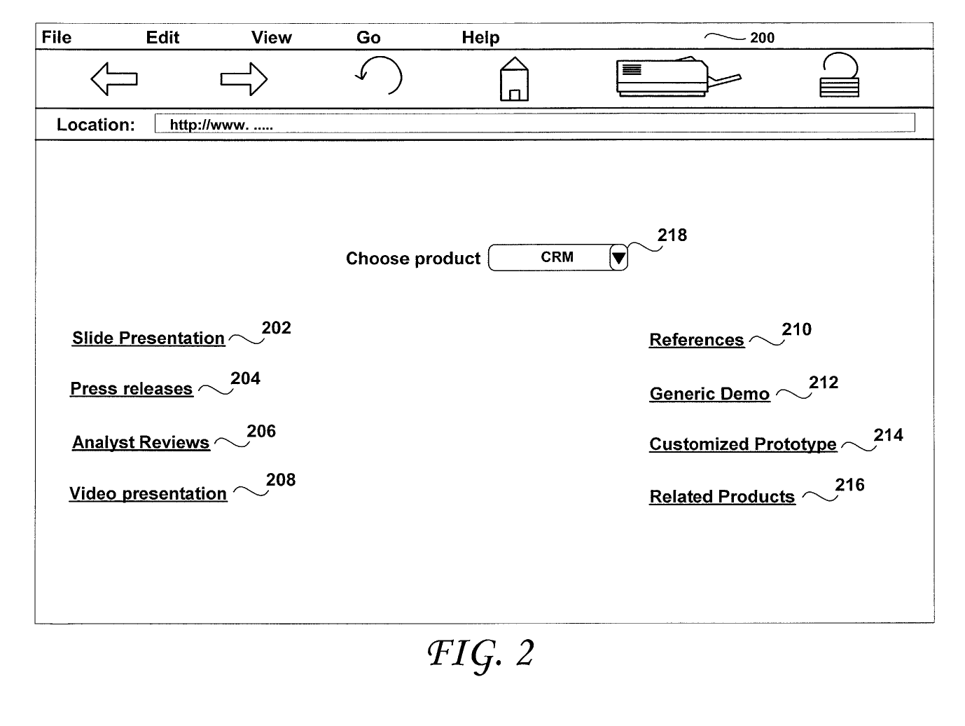

The present invention provides sales reps with effective tools for streamlining the sales cycle, from first contact with a potential customer to the sale of a product or service such as enterprise software. FIG. 2 shows one aspect of the present invention. As shown therein, an Internet browser 200 displays links to all materials that a sales rep may want to show to a potential customer during an entire sales cycle. Unlike conventional sales methodologies, the present invention provides for all sales materials to be aggregated into a single location, such as on a browser display. In this manner, the sales materials are immediately available to both the sales rep and the potential customer. Indeed, the browser display 200 shown in FIG. 2 (or one that is functionally similar to that shown in FIG. 2) is preferably displayed to both the sales rep and the potential customer at the same time. To do so, an Internet collaboration tool such as available from Webex.com may be used. The present invention, however, is not to be limited to such a proprietary platform, as any tool that enables the browser display 200 to be simultaneously visible and controllable to both potential customer and the sales rep over a computer network such as the Internet may be used within the context of the present invention. Moreover, the sales rep and the potential customer are advantageously coupled via a telephonic connection, to enable them to talk to one another as they navigate through the links shown in FIG. 2.

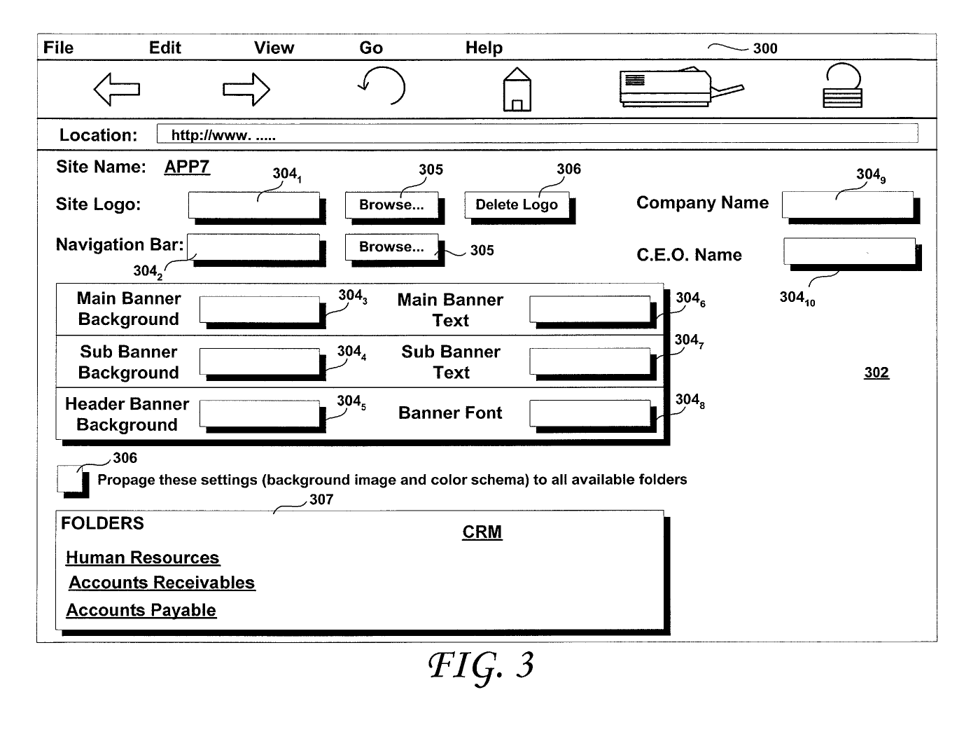

The sales materials that may be accessed through the browser display 200 include, for example, a three to five (for example) slide presentation 202 covering key business needs and an overview of the product and/or solution offered to address these identified key business needs. An architectural overview of the offered product/solution may also be included within the slide presentation 202. Press releases 204 describing the product or service offered may also be included. As shown at 206, analyst reviews and/or white papers may be included and displayed in the browser display 200, as may be references 210 from similarly situated customers that may have prior experience with the product or service offered. The references 210 may also include Web site URLs of other customers who have integrated the product or services offered into their own Web site. A link to a video presentation may also be present, as shown at 208. A static and generic product demo 212, including three to five (for example) screenshots of the product may also be provided. The static and generic demo 212 may advantageously include the primary workflow of the product or service offered and may outline the key differentiators of the product and/or solution relative to other offerings (if any) by competitors. A link to a customized prototype (a demo that has been customized to the potential customer's corporate identity and/or data, for example) may also be included, as shown at reference numeral 214, as described below relative to FIG. 3. Links to other related products may also be included, as shown at 216. For example, the related products link 216 may point to the sales rep's external company Web site and/or may deep link into the sales rep's company's e-Commerce store. Finally, a drop down menu or other product selector 218 may be present, enabling the sales rep and/or the potential customer to switch between product offerings, each offering preferably causing the display of like or similar links as those shown in FIG. 2. For illustrative purposes only, a Customer Relationship Management (CRM) product offering has been selected by either the sales rep or the potential client in FIG. 2. Not all of the links 202-218 need be present within the browser display 200. Similarly, some or all of the links identified in FIG. 2 may be replaced with links to other sales materials that are pertinent to the product and/or service offered by the sales rep.

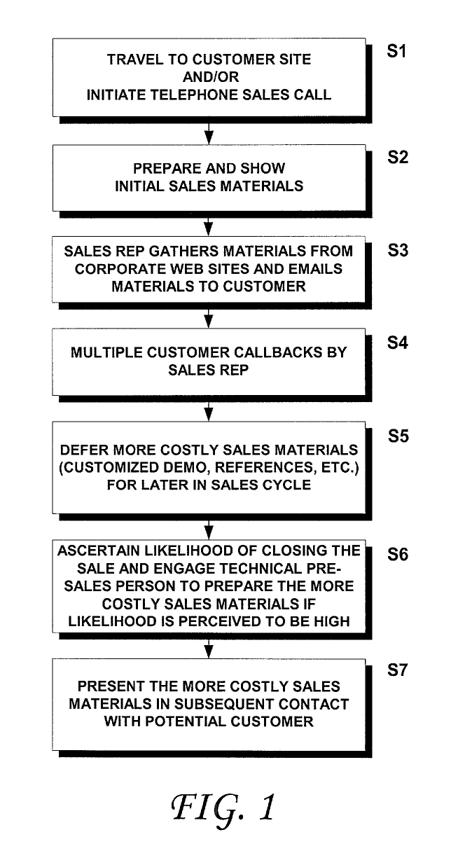

This integrated approach to the presentation and organization of the sales materials enables the sales rep and/or the potential customer to access and view any of the above-described sales materials in any order. For example, and in contradistinction to the conventional method illustrated in FIG. 1, the sales rep or the potential customer may decide to begin with the customized prototype, which would conventionally not be prepared or shown to the potential customer until well into the relationship or sales cycle. Indeed, the customized prototype may demonstrate the functionality of the product in a concrete and graphic manner and show how such functionality may address the potential client's identified business goals. Preferably, the sales materials featured on the browser 200 require little or no advance preparation and little or no self-training on the potential customer's part. This allows the sales rep to deliver the content to the potential customer with a relatively high degree of confidence that the materials convey the intended meaning.

According to embodiments of the present invention, for a given product/solution, all of the sales materials featured within the browser display 200 are available (as URL links, for example) on a single Web page. Therefore, any one of the materials may be shown to the potential customer instantly, by simply clicking on the appropriate link with a pointing device, such as a mouse. If desired, one or more (or all) of the sales materials may be shown to the potential customer in a single interaction, advantageously enabling the sales rep and the potential client to progress through an entire sales cycle in a single step. Preferably, the display 200 is simultaneously visible and active to both the sales rep and the potential customer by means of a Web collaboration tool or the like. This enables either the sales rep or the potential customer to select and to view any of the materials 202-216 in any order, at a pace determined by the interactions between the sales rep and the potential customer.

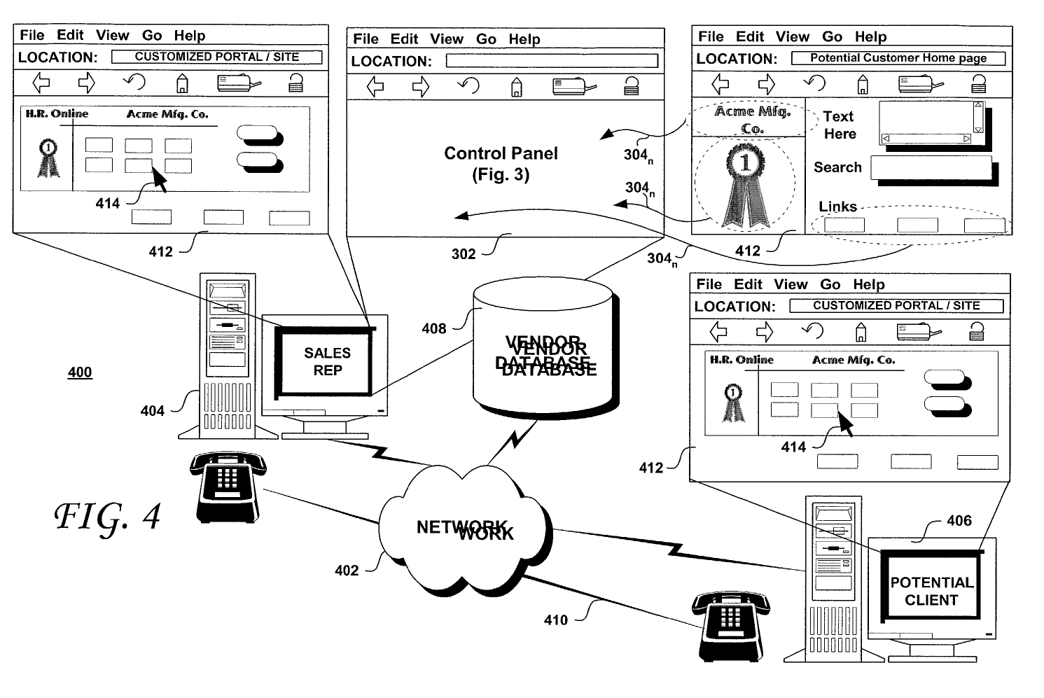

FIG. 3 is a representation of a browser display 300 showing the control panel 302 for creating customized browser-based demos, Web sites or customized portals (gateways to other locations on the World Wide Web), according to another embodiment of the present invention. The customized Web sites may include intranet portals, extranet portals and/or application portals, for example. As shown therein, the control panel 302 includes input fields for a plurality of customizable attributes 304₁ to 304₁₀. It is to be understood that, although an arbitrary ten such customizable attributes 304₁-304₁₀ are shown for illustrative purposes in FIG. 3, any number of such customizable attributes may be provided in the control panel 302. Inputting values, graphics, text and/or other configuration information into the input fields of the customizable attributes 304₁-304₁₀ enables the customization of one or more selected generic Web site or portal templates. According to the present invention, these generic Web site or portal templates may be stored in a database (such as shown at 408 in FIG. 4), and thereafter selectively retrieved therefrom and customized by means of the customizable attributes 304₁-304₁₀.

According to the present invention, the values, graphics, text and/or other configuration information inputted into the customizable attributes fields 304₁-304₁₀ may be advantageously (but need not be) retrieved directly from the potential customer's own Web site. Indeed, these values, text and/or other configuration information (such as fonts, colors, animation, graphics, navigation bars, textures, etc.), for example, may be cut and pasted from the potential customer's own Web site and inputted directly into appropriate ones of the fields of the customizable attributes 304₁-304₁₀ within the control panel 302. Thereafter, the selected generic Web site or portal template may be customized to the “look and feel” of the potential customer's existing Web site (for example) by re-generating the selected generic Web site or portal template with the values, text and/or other configuration information included therein. The customized portal or Web site may then be posted (to a Web collaboration tool, for example) and made available to the potential customer. Then end result is that a customized portal or Web site may be created in a short period of time (even while the potential customer is on the telephone with the sales rep) that resembles the look and feel or corporate identity of the potential customer's own Web site.

As shown in FIG. 3, these customizable attributes 304₁-304₁₀ may include, for example, input fields for the potential customer's logo or other graphic, as shown at 304₁. Such logo or graphic may include an image encoded as a .gif, a .jpg or a bitmapped image, for example. A button 305 may also be provided to enable the sales rep or other user to search a local or network drive (or a remote site, for example), for the desired graphic or logo. Another button 306 may be provided to delete the logo or graphic. A navigation bar taken from the potential customer's own Web site or selected from among pre-created exemplars may be inputted into the navigation bar customizable attribute input field 304₂. The navigation bar, for example, may provide a link to a supplier of the potential customer, or may provide a link to another internal Web site. When providing a link to another company, the navigation bar may have the look and feel of the underlying company or organization. For example, a soft drink manufacturer may provide a customized navigation bar to its aluminum can supplier. A Browse button 305 may also be provided to enable the sales rep or control panel user to select a suitable navigation bar. Similarly, to customize the look of the selected generic portal or Web site template, values for the main banner background, sub banner background, header banner background, main banner text, sub banner text and/or banner font (for example) taken from the potential customer's Web site (for example) may also be inputted into the input fields identified in FIG. 3 by reference numerals 304₃-304₈, respectively. The name and the Chief Executive Officer (CEO) of the potential customer's company (and/or any other relevant or compelling content) may also be inputted into the control panel 302, as shown at 304₉-304₁₀. Of course, the customizable attributes 304₁-304₁₀ shown in FIG. 3 are but examples of possible attributes that may be customized via the control panel 302, and the present invention should not be limited by such illustrative examples. Links to one or more folders, as shown at 307, may be included in the control panel 302. Such folders 307 may include links to one or more Web-enabled applications, such as, for example, a Human Resources Web application, Accounts Receivable or Payable applications or a CRM application that the sales rep may show to the potential customer. The values inputted into the input fields of the customizable attributes 304₁-304₁₀ may be propagated to the applications listed in the folders 307 by selecting the button 306. This customizes the applications with the look and feel of the customer's own Web site and/or corporate identity. In this manner, the CRM application or a demo or prototype thereof, for example, may be quickly configured to match the potential customer's corporate identity. This enables the potential customer to immediately see how such applications would appear if they were purchased from the sales rep and integrated their own Web site. This customization mechanism allows the customization to be carried out prior to or even during a telephone conference with the potential customer and effectively heightens the immediacy and impact of the sales rep's presentation and increases the likelihood that the potential customer will actually purchase the featured product or products. After the customization of the portal and/or folders 307, the link 214 to the prototype may be made to point to the appropriate customized application (customized by means of the control panel 302), such as the CRM application selected at 218 in FIG. 2. The customized portal, web site or application may then be posted to a Web collaboration tool and simultaneously viewed and acted upon by both the sales rep and the potential customer.

FIG. 4 is a diagram of a system 400 for conducting online sales calls, according to a still further embodiment of the present invention. As shown therein, the system 400 may include a computer network 402 (including the Internet, a private network and/or a Virtual Private Network (VPN), for example), to which the sales rep and the potential customer (represented in FIG. 4 by computing devices 404 and 406, respectively) are coupled. Also coupled to the network 402 is a database 408. The database 408 may store the screen definitions of the Web applications shown in the folders 307, as well as the generic Web site and portal templates to which the customizable attributes 304₁-304₁₀ are applied to generate the customized Web sites or portals according to the present invention. The choice of which generic Web site or portal template is selected may be driven by the content and/or layout that the customer seeks in their Web site or portal prototype. The sales rep and the potential customer may be in telephonic communication with one another during the entire sales cycle or portions thereof, as shown at 410. According to the present invention, the sales rep may access the potential customer's Web site 412, and retrieve therefrom selected graphics, text, fonts, color schemes and the like and input these into the control panel 302, as detailed above, as suggested by the arrows labeled 304ₙ. The retrieved graphics, text, fonts, color schemes and the like may then be applied to one or more generic templates to create one or more customized Web sites or portals, as shown at 412. The customized Web site or portal 412 may then be posted to a Web collaboration tool or to some other utility that enables the customized portal or site 412 to be simultaneously visible and acted upon by both the sales rep 404 and the potential customer 406 over the network 402. Thereafter, any action carried out by the sales rep (by moving a cursor 414, for example) will be mirrored in the display visible to the potential customer. Similarly, any action carried out by the potential customer on the customized portal or Web site 412 will be seen by the sales rep. In this manner, the sales pitch becomes a collaborative experience between the sales rep and the potential customer, as either may drive the progression of the sales call and/or the order in which the sales materials are shown and discussed. The present invention is advantageously employed in a repository-based environment. In such a repository-based environment, applications may run by extracting screen display definitions from database tables at run time. By altering the customizable attributes described above, the appearance of the application may be altered the next time the application is executed.

### Hardware Overview

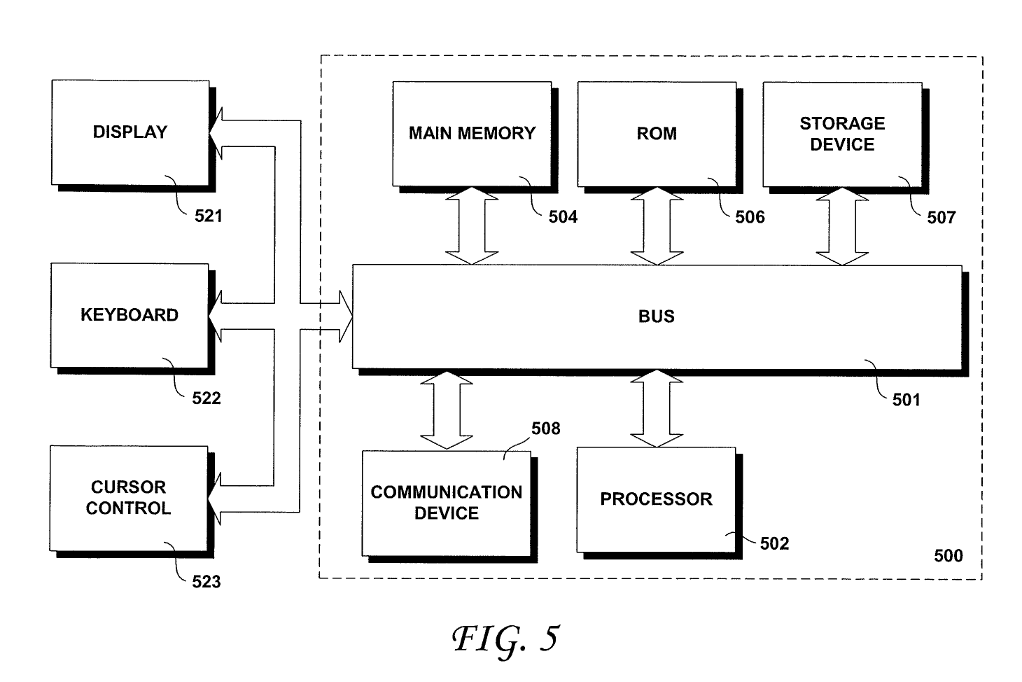

FIG. 5 illustrates a block diagram of a computer 500 with which an embodiment of the present invention may be implemented. Computer system 500 includes a bus 501 or other communication mechanism for communicating information, and a processor 502 coupled with bus 501 for processing information. Computer system 500 further comprises a random access memory (RAM) or other dynamic storage device 504 (referred to as main memory), coupled to bus 501 for storing information and instructions to be executed by processor 502. Main memory 504 also may be used for storing temporary variables or other intermediate information during execution of instructions by processor 502. Computer system 500 also includes a read only memory (ROM) and/or other static storage device 506 coupled to bus 501 for storing static information and instructions for processor 502. A data storage device 507, such as a magnetic disk or optical disk, is coupled to bus 501 for storing information and instructions. A communication device 508 to connect the computer system to the network may also be coupled to the bus 501, such as a modem or a network adapter.

Computer system 500 may also be coupled via bus 501 to a display device 521, such as a cathode ray tube (CRT), for displaying information to a computer user. An alphanumeric input device 522, including alphanumeric and other keys, is typically coupled to bus 501 for communicating information and command selections to processor 502. Another type of user input device is cursor control 523, such as a mouse, a trackball, or cursor direction keys for communicating direction information and command selections to processor 502 and for controlling cursor movement on display 521. This input device typically has two degrees of freedom in two axes, a first axis (e.g., x) and a second axis (e.g., y), which allows the device to specify positions in a plane. Alternately, a stylus or pen may be used to interact with the display. A displayed object on a computer screen may be selected by using a stylus or pen to touch the displayed object. The computer detects the selection by implementing a touch sensitive screen. Similarly, a light pen and a light sensitive screen may be used for selecting a displayed object. Such devices may thus detect selection position and the selection as a single operation instead of the “point and click,” as in a system incorporating a mouse or trackball. Stylus and pen based input devices as well as touch and light sensitive screens are well known in the art. Such a system may also lack a keyboard such as 522, in which case all interactions therewith may be carried out via alternative input devices, such as a stylus and the written text may be interpreted using optical character recognition (OCR) techniques, for example.

The present invention is related to the use of computer system 500 to provide methods and systems for selling products such as software online. According to one embodiment, the methods according to the present invention are implemented by one or more computer systems 500 in response to processor(s) 502 executing sequences of instructions contained in memory 504. Such instructions may be read into memory 504 from another computer-readable medium, such as data storage device 507. Execution of the sequences of instructions contained in memory 504 causes processor(s) 502 to perform the process steps that are described above. In alternative embodiments, hard-wired circuitry may be used in place of or in combination with software instructions to implement all or selected portions of the present invention. Thus, the present invention is not limited to any specific combination of hardware circuitry and software.

While the foregoing detailed description has described preferred embodiments of the present invention, it is to be understood that the above description is illustrative only and not limiting of the disclosed invention. Indeed, those of skill in this art will recognize other alternative embodiments and all such embodiments are deemed to fall within the scope of the present invention. Thus, the present invention should be limited only by the claims as set forth below.

What is claimed is:

1. Method of creating a customized Web site for a customer, comprising the steps of:
selecting one of a plurality of stored generic Web site templates, each of the plurality of generic Web site templates including a plurality of customizable attributes;
retrieving at least one of a graphic, text and configuration information from a Web site of the customer;
customizing a look of the selected generic Web site template by selectively inputting the retrieved at least one of graphic, text and configuration information into the customizable attributes.

2. The method of claim 1, further comprising the step of running at least one Web application or demo from the Web site, the Web application or demo being configured to extract screen display definitions from database tables within a database and to customize the extracted screen display definitions according to the retrieved at least one graphic, text and configuration information.

3. The method of claim 1, further comprising the step of inputting the retrieved at least one of graphic, text and configuration information into a control panel, the control panel being configured to apply the retrieved at least one graphic, text and configuration information to the selected generic Web site template.

4. The method of claim 1, wherein the at least one of graphic, text and configuration information of the customized Web site includes a look and feel of the customer's Web site.

5. The method of claim 1, wherein the look and feel of the customized Web site includes at least one of color schemes, fonts, links, animation, navigation bars and texture of the customer's Web Site.

6. The method of claim 1, wherein the plurality of Web site templates includes a template for an extranet portal, and intranet portal and an applications portal.

7. A method for selling software online, comprising the steps of:
posting sales materials to an online collaboration tool, the online collaboration tool enabling both a sales representative and a potential customer to view the posted sales materials simultaneously, the sales materials including at least one of a presentation, a press release, an analyst review and a customer reference;
accessing a Web site of the potential customer and retrieving at least one of a graphic, text and configuration information therefrom;
customizing a look of a generic Web site template with the retrieved at least one of graphic, text and configuration information to create a customized Web site;
posting the customized Web site to the online collaboration tool and causing the customized Web site to be displayed for the potential customer.

8. The method of claim 7, further comprising the step of carrying out a telephone conference with the potential customer and wherein the accessing and posting steps are carried out during the telephone conference.

9. The method of claim 1, wherein the generic Web site template is selected from an extranet portal, an intranet portal and an applications portal.

10. The method of claim 7, further comprising the step of running at least one Web application from the customized Web site, the Web application being configured to extract screen display definitions from database tables within a database and to modify the extracted screen display definitions according to the retrieved at least one graphic, text and configuration information.

11. The method of claim 7, further comprising the step of inputting the retrieved at least one of graphic, text and configuration information into a control panel, the control panel being configured to apply the retrieved at least one graphic, text and configuration information to the accessed generic Web site template.

12. The method of claim 7, wherein the configuration information of the customized Web site includes a look and feel of the customer's Web site.

13. The method of claim 7, wherein the look and feel of the customized Web site includes at least one of color schemes, fonts, links, navigation bars, animation and texture of the customer's Web Site.

14. The method of claim 8, wherein the sales materials and the customized Web site are viewed by both the potential customer and the sales rep in an order determined during the telephone conference.

15. The method of claim 7, further comprising the step of running at least one application or demo from the customized Web site, the at least one application or demo also being customized by the retrieved at least one of graphic, text and configuration information.

16. A system for creating and sharing a customized Web site or demo, comprising:
a first Web site, the first Web site including a plurality of input fields for a corresponding plurality of customizable attributes, each of the plurality of input fields being configured to accept at least one attribute of a second Web site;
a plurality of generic Web site templates; and
means for applying the at least one attribute of the first Web site to at least one of the plurality of generic Web site templates to generate the customized Web site or demo, the customized Web site or demo being configured to resemble a look and feel of the second Web site.

17. The system of claim 16, wherein the customized Web site includes one of an intranet portal, an extranet portal and an applications portal.

18. The system of claim 16, wherein the customizable attributes of the first Web site includes at least one of graphics, text, configuration information, color schemes, fonts, links, animations, navigation bars, texture and layout of the second Web Site.

19. The system of claim 16, further including a Web collaboration tool configured to enable the customized Web site or demo to be simultaneously viewed and acted upon by at least a first and a second party.

20. The system of claim 19, wherein the first party includes a sales rep and the second party includes a potential customer.

21. The system of claim 19, further including a telephone connection between the first and the second party.

22. The system of claim 16, further including a database, the database being configured to store the plurality of generic Web site templates.

23. The system of claim 22, wherein the database is configured to store a Web-enabled application configured to be launched from the customized Web site.

24. The system of claim 23, wherein the Web-enabled application is adapted to change its appearance according to the at least one attribute from the second Web site.
